(19) United States
(12) Patent Application Publication
(10) Pub. No.: US 2009/0077500 A1
(43) Pub. Date: Mar. 19, 2009

(54) WEB SPACES NAVIGATION MODULE

(75) Inventors: Brian M. Perrin, Redmond, WA (US); Karen G. Luk, Seattle, WA (US); Cinthya R. Urasaki, Seattle, WA (US); Robert M. Dolin, Seattle, WA (US)

Correspondence Address: SENNIGER POWERS LLP (MSFT), 100 NORTH BROADWAY, 17TH FLOOR, ST. LOUIS, MO, 63102, US

(73) Assignee: MICROSOFT CORPORATION, Redmond, WA (US)

(21) Appl. No.: 11/857,910

(22) Filed: Sep. 19, 2007

(51) Int. Cl. G06F 3/048

(52) U.S. Cl. 715/835

(57) ABSTRACT

A navigation bar in connection with the web space is generated based on the type of user and the control setting of the web space and includes one or more controls for navigating the web space. A client accessing the web space receives and renders the generated navigation bar. The navigation bar is responsive to an input device of the client and accepts a selection of at least one of the controls from the navigation bar via the input device. The selected control navigates to a predetermined portion of the web space.

### BACKGROUND

Many computer users enjoy using the Internet as a platform for social networking. Personal Internet services, implemented in software, allow users to access relationships, information, and interests through a web space. In general, a user creates and customizes his or her web space with content personal to the user. For example, a user may create a web log, or “blog” (a series of entries written in chronological order and displayed in reverse chronological order) to express thoughts or ideas; create lists of favorite songs, books, web spaces or movies; keep up with friends and family; meet new people; publish photos online through the web space; and the like. Additionally, some web spaces interface with instant messaging utilities (a form of real-time communication between two or more people based on typed text) and other utilities that allow a visitor to the web space to interact with the web space (i.e., sign a guest book or leave comments).

### SUMMARY

Embodiments of the invention overcome one or more vulnerabilities associated with navigating a web space. Aspects of the invention identify a type of user accessing the web space and determine a control setting of the web space. A navigation bar in connection with the web space is generated based on the type of user and the control setting of the web space and includes one or more controls for navigating the web space. A client accessing the web space receives and renders the generated navigation bar. The navigation bar is responsive to an input device of the client and accepts a selection of at least one of the controls from the navigation bar via the input device. The selected control navigates to a predetermined portion of the web space. The navigation bar provides a uniform experience for both users and visitors to the web space even though the controls with the navigation bar are customizable.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating one example of a suitable computing system environment in which the invention may be implemented.

FIG. 2 is a block diagram illustrating an exemplary navigation bar according to an embodiment of the invention.

FIG. 3 is an exemplary screen shot illustrating aspects of a web space user interface including the navigation bar of FIG. 2.

FIG. 4 is an exemplary flow diagram illustrating a method for associating a service to a web space.

FIG. 5 is an exemplary flow diagram illustrating a method for associating a plurality of services to a web space for a user.

Corresponding reference characters indicate corresponding parts throughout the drawings.

### DETAILED DESCRIPTION

Referring now to the drawings, aspects of the invention implement a navigation model for use with a personal web site, i.e., a “space.” Through a web space, a user can publish text, photos, and other information for sharing and interacting with others. Because web spaces are, by their very nature, shared with others, the ability to easily navigate a web space is important.

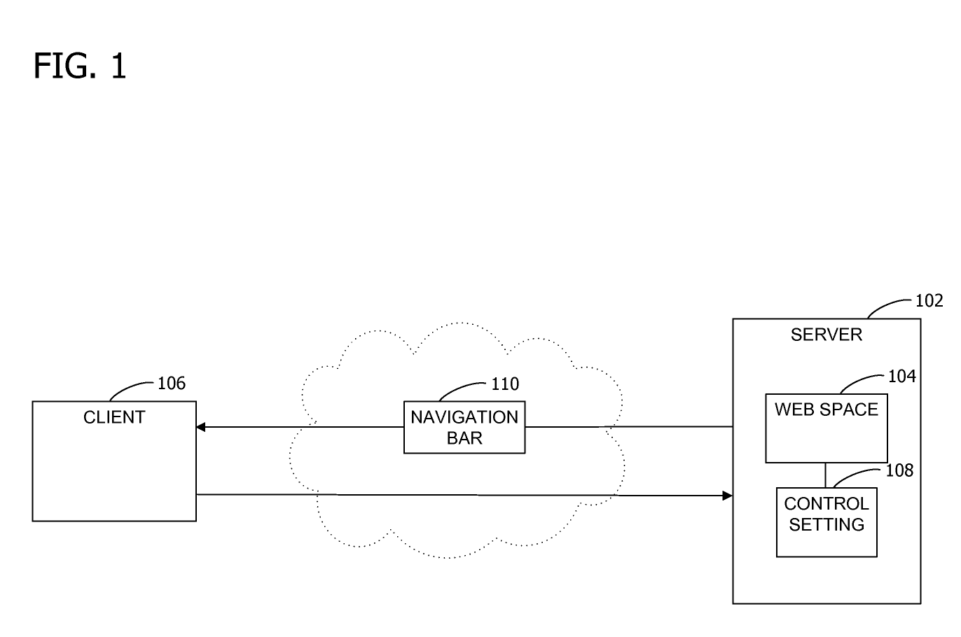

FIG. 1 is a block diagram illustrating one example of a suitable computing system environment in which the invention may be implemented. The system includes a server 102 hosting a web space 104. In the illustrated embodiment, a client 106 accesses the web space 104 via a communication network. The server 102 identifies a type of user accessing the web space 104 via the client 106. For example, the identified type of user includes one or more of the following: an owner of the web space 104 and a visitor to the web space 104.

Additionally, the server 102 determines a control setting 108 of web space 104. In an embodiment, the control setting 108 is specified by an owner of web space 104 and the control setting 108 specifies a format of the web space 104. In an embodiment, the control setting 108 indicates a preference of the owner of web space 104 regarding permissions or formatting. For example, the control setting 108 may indicate that visitors to the web space 104 may leave comments or sign a guest book. In another example, control setting 108 specifies that a music list appears in the web space 104 in a green font.

The server 102 generates a navigation bar 110 in connection with the web space 104 based on the type of user and the control setting 108 of web space 104. The navigation bar 110 includes one or more controls for navigating the web space 104. For example, the navigation bar 110 is contextually based on who accesses the web space (visitor or owner) and the control setting of the page. Alternatively, the navigation bar 110 is contextually based on the owner's market (e.g., geographic location) or based on the login status of the user (e.g., signed in or signed out).

For example, a visitor may access one or more controls for photo sharing if the web space 104 of the owner includes photos. Furthermore, the control is configurable according to context. For example, the visitor to the web space 104 has the option of viewing the posted photos in a large photo viewer or a small photo viewer, but the visitor is not permitted to add photos to the owner's web space 104. Thus, only controls for viewing photos are included in the visitor's navigation bar 110. On the other hand, the owner of web space 104 can add photos to his or her own web space 104. Thus, the owner's navigation bar 100 includes a control for adding photos in the navigation bar 110.

In another embodiment, the navigation bar 110 includes controls for one or more of the following if the user is the owner of the web space 104: adding content to web space 104, deleting content to web space 104, updating content to web space 104, and formatting content to web space 104. Alternatively, if the user is the visitor to the web space 104, the navigation bar 110 includes controls for one or more of the following: adding feedback to the web space 104, signing a guestbook of the web space 104, and displaying content of the web space 104. These various controls may be in addition to or instead of the controls described above. Those skilled in the art will appreciate that the list of controls described herein is not exhaustive as other controls are contemplated according to the context in which the web space is being used.

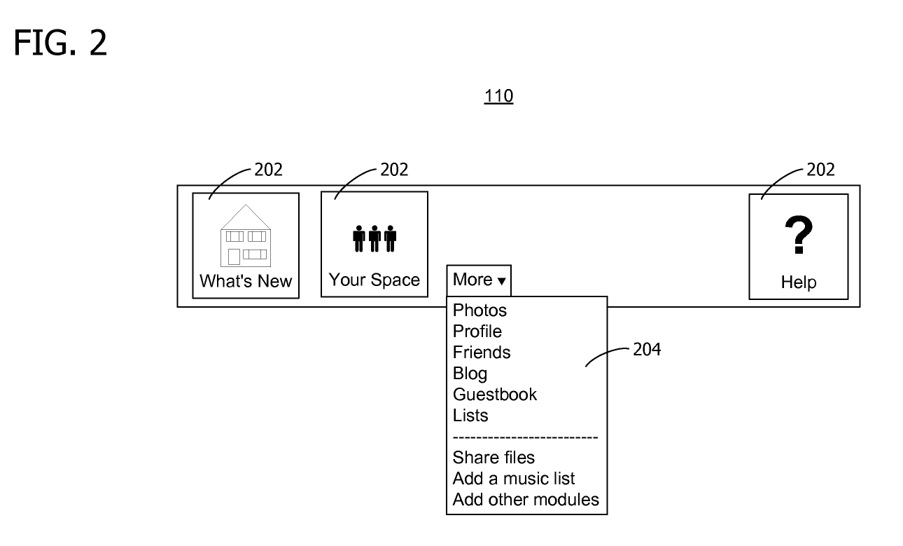

FIG. 2 illustrates an exemplary embodiment of the navigation bar 110 according to aspects of the invention. In an embodiment, the navigation bar 110 includes one of the more of the following: a navigation link 202 and a menu 204. In this embodiment, the server 102 exposes a method for adding one or more of the following to the navigation bar 110: a navigation link 202 and a navigation menu 204. The navigation link 202 is rendered in one or more of the following formats on the client 106: an icon, an icon with text, and text only. And, the server 102 exposes methods for one or more of the following: adding menu items to navigation menu 204 and deleting menu items from navigation menu 204. The menu items are rendered in the order in which they are added to navigation menu 204.

In another embodiment, the navigation bar 110 includes one or more of the following sections: a secondary navigation section between web space 104 modules; a tertiary navigation section within a web space 104 module; a utility section for tools and customization of the web space 104; and a help section for help pages for the web space 104.

The sections of navigation bar 110 are rendered on the client 106 in the order in which they are added to the navigation bar 110. Alternatively, the navigation bar 110 comprises a secondary navigation section including a default set of navigation links 202 for navigating the web space 104.

Referring again to FIG. 1, the client 106 accesses web space 104 hosted on the server 102 via a data communication network. The logical connections representing the data communication network depicted in FIG. 1 include a local area network (LAN) and a wide area network (WAN), but may also include other networks. LAN and/or WAN may be a wired network, a wireless network, a combination thereof, and so on. Such networking environments are commonplace in offices, enterprise-wide computer networks, intranets, and global computer networks (e.g., the Internet).

The client 106 receives, via the data communication network, the navigation bar 110 generated by the server 102. And the navigation bar 110 is responsive to an input device of the client 106. Those skilled in the art are familiar with numerous method of entering user input. For example, the user may enter commands and information into client 106 through input devices or user interface selection devices such as a keyboard and a pointing device (e.g., a mouse, trackball, pen, or touch pad). Other input devices may include a microphone, joystick, game pad, satellite dish, scanner, or the like. A monitor or other type of display device is also connected to the client 106 via an interface, such as a video interface. In addition to the monitor, computers often include other peripheral output devices such as a printer and speakers, which may be connected through an output peripheral interface.

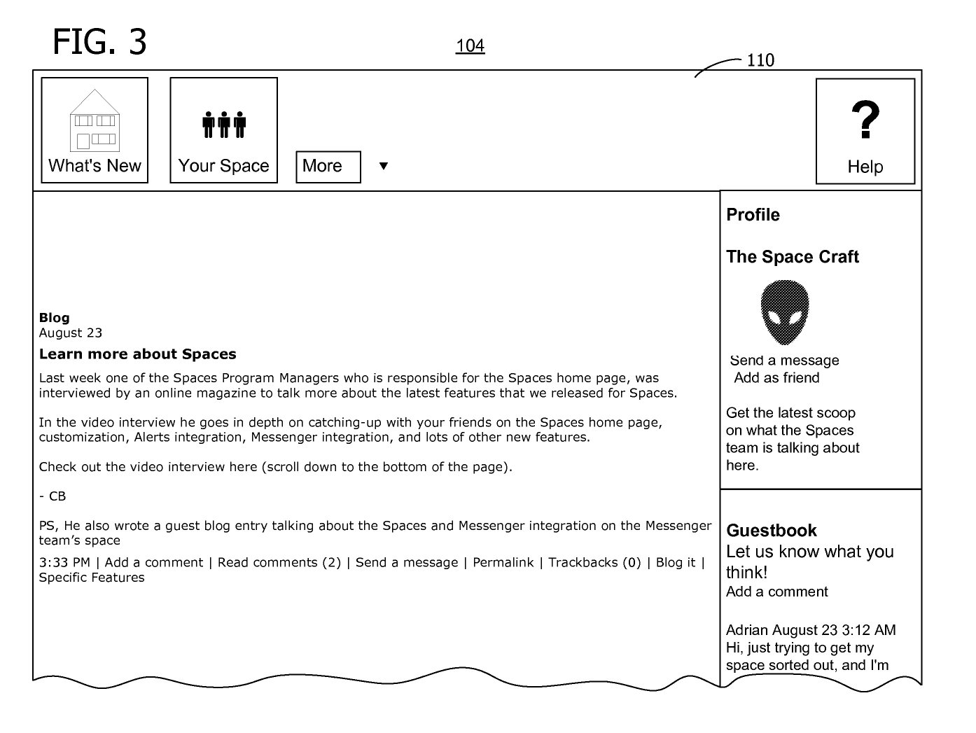

The client 106 accepts a selection of at least one of the controls from the navigation bar 110 by the user via the input device of the client 106. The selected control navigates to a predetermined portion of the web space 104. In an embodiment, the navigation bar 110 is implemented in one or more of the following: HTML (Hypertext Markup Language) and CSS (Cascading Style Sheets). FIG. 3 illustrates an exemplary embodiment of the web space 104 including the navigation bar 110 rendered on client 106 according to aspects of the invention.

Referring again to FIG. 1, in another embodiment, the server 102 initializes a script for controlling user input via the input device of the client 106. The client 106 receives the script from the server 102 and executes the script in response to the receiving. The script is executed as the web space is rendered on the client 106.

While described above in the context of web space 104, aspects of the navigation bar 110 are useful in navigating other types of sites such as an email site, an event site, and a group site. Furthermore, the navigation bar 110 in one embodiment in configured to pivot (or change) based on site type. The navigation bar 110 is dynamically updated to display a status.

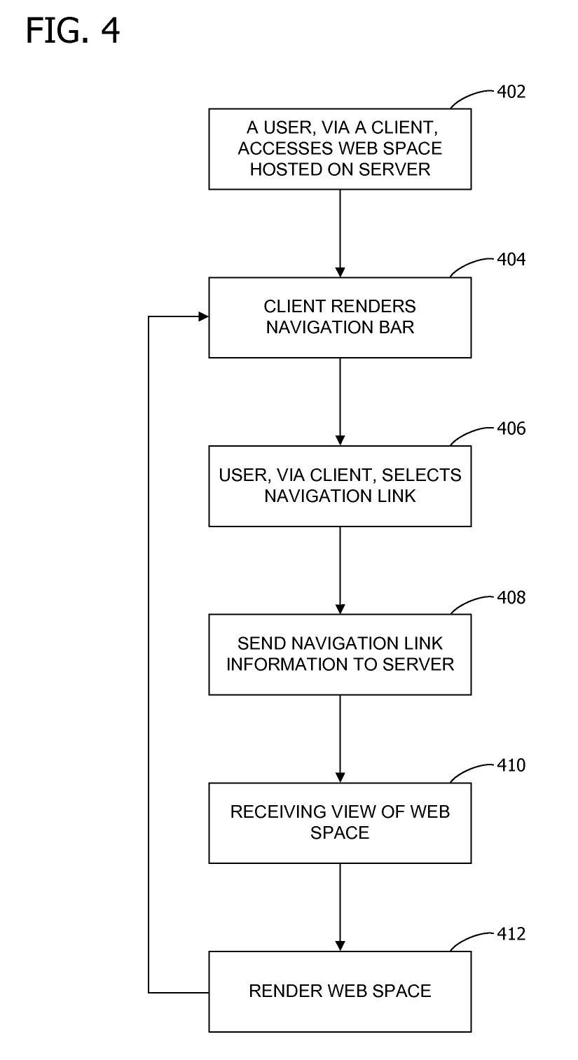

FIG. 4 is an exemplary flow diagram illustrating a method for enabling navigation of a web space 104 by a user. At 402, the user accesses the web space 104 at client 106 coupled via a data communication network to server 102 hosting the web space 104.

At 404, the client 106 renders navigation bar 110 in connection with web space 104 accessed at client 106. The navigation bar 110 is generated by server 102 based on an identified type of user accessing the web space 104 and a determined control setting 108 of web space 104. In an embodiment, the type of user includes one or more of the following: an owner of the web space 104 and a visitor to the web space 104.

The navigation bar 110 includes one or more navigation links 202 for navigating the web space 104 in response to user input. At 406, the user selects at least one navigation link 202 from the navigation bar 110 via user input received at the client 106. And at 408, the client 106 sends information representative of the selected navigation link 202 to server 102 via the data communication network. The server 102 executes a control to generate the view of web space 104 based on the selected navigation link 202. In an embodiment, the navigation links 202 are constructed from a prioritized list of services, which are compared against the services present on the current web space 104.

At 410, the client 106 receives a view of web space 104 from the server 102. And. at 412, the client renders the received view of web space 104 to the user on the client 106. In an embodiment, the process repeats steps 404-412 until the user navigates away from the web space 104.

Although described in connection with an exemplary computing system environment, including client 106, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

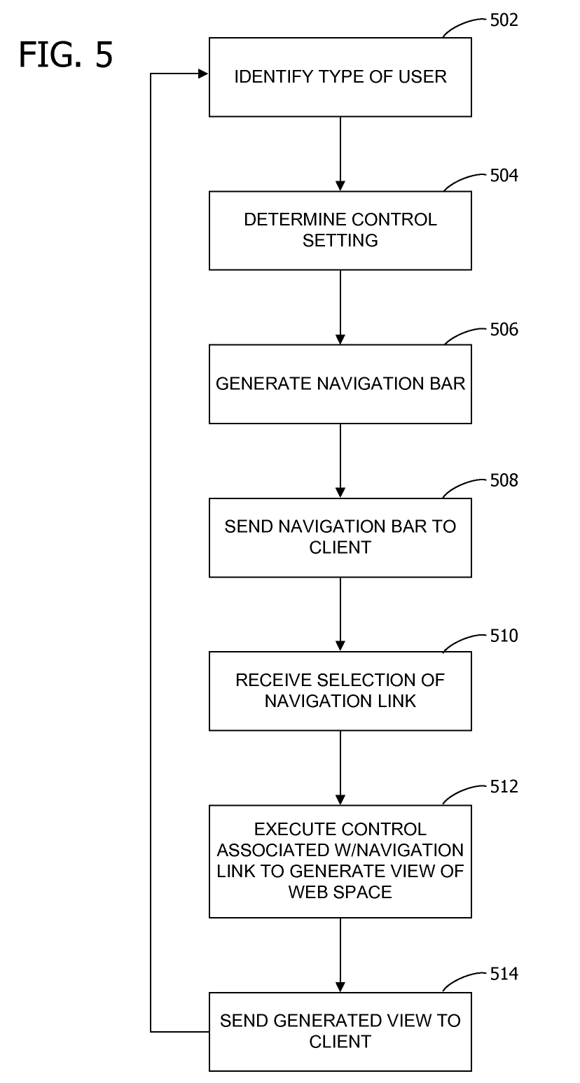

FIG. 5 is an exemplary flow diagram illustrating method for enabling navigation of web space 104 hosted by server 102. At 502, the server 102 identifies a type of user accessing the web space 104 at client 106. In an embodiment, the type of user includes one or more of the following: an owner of the web space 104 and a visitor to the web space 104. The client 106 is coupled to the server 102 hosting web space 104 via a data communication network.

At 504, the server determines a control setting 108 of the web space 104. And. at 506, the server generates a navigation bar 110 based on the type of user and the control setting 108 of the web space 104. The navigation bar 110 includes one or more navigation links 202 for navigating the web space 104.

At 508, the server 102 sends the navigation bar 110 to the client 106 via the data communication network. The client 106 renders the received navigation bar 110 in connection with the web space 104 and the navigation bar 110 is responsive to user input received at the client 106.

At 510, the server 102 receives a selection of at least one navigation link 202 from client 106. The navigation link 202 is selected from the navigation bar 110 by a user via user input at the client 106. At 512, the server 102 executes a control for generating a view of the web space 104 based on the received selection. And at 514, the server 102 sends the generated view of the web space 104 to the client 106 for rendering to the user. In an embodiment, steps 502-514 repeat until the client navigates away from the web space 104.

In another embodiment, the server 102 a script in response to the received selection and sending the initialized script to the client 106 for execution. The execution of the script causes the generated view of the web space 104 to be rendered on the client 106.

Referring again to FIG. 1, FIG. 1 shows an example of a general purpose computing device in the form of a computer (e.g., server 102, client 106). In one embodiment of the invention, a computer such as the computer (e.g., server 102, client 106) is suitable for use in the other figures illustrated and described herein. The computer has one or more processors or processing units and a system memory. The computer (e.g., server 102, client 106) typically has at least some form of computer readable media. Computer readable media, which include both volatile and nonvolatile media, removable and non-removable media, may be any available medium that may be accessed by computer (e.g., server 102, client 106). By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer (e.g., server 102, client 106).

Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computer (e.g., server 102, client 106) executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A system comprising:
a server hosting a web space, said server being configured for:
identifying a type of user accessing the web space;
determining a control setting of the web space;
generating a navigation bar in connection with the web space, said navigation bar including one or more controls for navigating the web space based on the type of user and the control setting of the web space;
a client accessing the web space, said client being coupled to the server via a data communication network, said client further being configured for:
receiving, via the data communication network, the navigation bar generated by the server;
rendering the received navigation bar, said navigation bar being responsive to an input device of the client;
accepting a selection of at least one of the controls from the navigation bar by the user via the input device of the client, wherein the selected control navigates to a predetermined portion of the web space associated with therewith.

2. The system of claim 1, wherein the type of user includes one or more of the following: an owner of the web space and a visitor to the web space.

3. The system of claim 1, wherein the navigation bar includes controls for one or more of the following if the user is the owner of the web space: adding content to the web space, deleting content to the web space, updating content to the web space, and formatting content to the web space.

4. The system of claim 1, wherein the navigation bar includes controls for one or more of the following if the user is the visitor to the web space: adding feedback to the web space, signing a guestbook of the web space, and displaying content of the web space.

5. The system of claim 1, wherein the navigation bar includes one of the more of the following: a navigation link and a menu.

6. The system of claim 1, wherein the server is further configured for executing instructions for initializing a script; and
the client is further configured for executing instructions for:
receiving the script from the server; and
executing the script in response to the receiving.

7. The system of claim 1, wherein the navigation bar includes one or more of the following sections: a secondary navigation section between web space modules; a tertiary navigation section within a web space module; a utility section for tools and customization of the web space; and a help section for help pages for the web space.

8. The system of claim 7, wherein the sections of the navigation bar are rendered in the order in which they are added to the navigation bar.

9. The system of claim 1, wherein the server exposes a method for adding one or more of the following to the navigation bar: a navigation link and a navigation menu.

10. The system of claim 9, wherein the navigation link is rendered in one or more of the following formats: icon, icon with text, and text only.

11. The system of claim 9, wherein the server exposes methods for one or more of the following: adding menu items to the navigation menu and deleting menu items from the navigation menu.

12. The system of claim 11, wherein the menu items are rendered in the order in which they are added to the navigation menu.

13. The system of claim 1, wherein the navigation bar comprises a secondary navigation section including a default set of navigation links for navigating the web space.

14. The system of claim 1, wherein the navigation bar is implemented in one or more of the following: HTML and CSS.

15. The system of claim 1, wherein the control setting is specified by an owner of the web space and the control setting specifies a format of the web space.

16. A method for enabling navigation of a web space by a user, said method comprising:
accessing the web space at a client coupled via a data communication network to a server hosting the web space;
rendering a navigation bar in connection with the web space accessed at the client, said navigation bar being generated by the server based on an identified type of user accessing the web space and a determined control setting of the web space, said navigation bar including one or more navigation links for navigating the web space in response to user input;
selecting at least one navigation link from the navigation bar via user input received at the client;
sending information representative of the selected navigation link from the client to the server via the data communication network;
receiving, at the client, a view of the web space from the server wherein the server executed a control generating the view of the web space based on the selected navigation link; and
rendering the received view of the web space to the user on the client.

17. The system of claim 16, wherein the type of user includes one or more of the following: an owner of the web space and a visitor to the web space.

18. A method for enabling navigation of a web space hosted by a server, said method comprising:
identifying a type of user accessing the web space at a client, said client being coupled to the server hosting the web space via a data communication network;
determining a control setting of the web space;
generating a navigation bar based on the type of user and the control setting of the web space, said navigation bar including one or more navigation links for navigating the web space;
sending the navigation bar from the server to the client via the data communication network, wherein the client renders the received navigation bar in connection with the web space and wherein the navigation bar is responsive to user input received at the client;
receiving, at the server, a selection of at least one navigation link from the client, said selected navigation link being selected from the navigation bar by a user via user input at the client;
executing, at the server, a control for generating a view of the web space based on the received selection; and
sending the generated view of the web space to the client for rendering to the user.

19. The method of claim 18, wherein the type of user includes one or more of the following: an owner of the web space and a visitor to the web space.

20. The method of claim 18, further comprising initializing a script in response to the received selection and sending the initialized script to the client for execution, wherein execution of the script cause the generated view of the web space to be rendered.
